(19) United States
(12) Patent Application Publication
(10) Pub. No.: US 2015/0096990 A1
(43) Pub. Date: Apr. 9, 2015

(54) Handway/Manway Installation Stay Bracket System

(71) Applicant: Steven Richard Ambriz, Missouri City, TX (US)

(72) Inventor: Steven Richard Ambriz, Missouri City, TX (US)

(21) Appl. No.: 14/046,983

(22) Filed: Oct. 6, 2013

(51) Int. Cl. F16J 13/06; F16J 13/22

(52) U.S. Cl. CPC F16J 13/065; F16J 13/22
USPC 220/316; 220/318; 220/324

(57) ABSTRACT

A cover assembly for an access opening in a pressure vessel is held in sealing position at least partially by the positive pressure in the pressure vessel by engaging an interior wall of the pressure vessel when the pressure vessel is under pressure. A peripheral rim on the housing is adapted for engaging the interior wall of the pressure vessel, and positioning tabs on the housing engage and position the housing and the peripheral rim relative to the access opening in the pressure vessel.

### BACKGROUND

1. Field of the Invention

The invention is generally related to pressure tanks or vessels having handway or manway access ports which are closed when the tank or vessel is under pressure and is specifically directed to a handway/manway cover and gasket which seals the port when the tank or vessel is under pressure.

2. Discussion of the Prior Art

A handway or manway assembly permits access to the inside of a pressure vessel by providing a pressure sealed removable cover in an exterior wall of the vessel. Typically, the pressurization of the vessel provides the force for holding the cover in place and for sealing the cover and opening in the vessel from leaks. Once the vessel is depressurized the cover may be removed from the engaged position to permit access to the interior of the vessel. In the engaged position the cover seals the access opening by means of a gasket and hardware to hold the cover in the internal sealing position.

There are numerous handway or manway covers in the art. An example of a typical cover is the elliptical handway or manway assembly offered by Axxiom Manufacturing, Inc. of Fresno, Tex. This cover allows the cover to be inserted externally through the handway or manway opening and rotated into the internal sealing position. The handway or manway cover and gasket is then forcibly held in the sealing position to allow installation of the holding hardware. In doing so the handway/manway installation stay bracket system allows for easier installation of the handway or manway holding hardware.

This cover system is more than adequate for functionally sealing the opening in the vessel and for permitting ready access when the pressurized vessel is depressurized. However, it would be useful to provide manway or handway cover system which is easier to position and secure in the access opening.

### SUMMARY OF THE INVENTION

The subject invention is directed to a handway/manway installation stay bracket system for a typical pressure vessel having a handway or manway access opening for providing access to the inside of the pressure vessel by removing the handway or manway cover from the engaged position when the vessel is depressurized. As is typical, in the engaged position the cover seals the access opening by means of a gasket and hardware to hold the cover in the internal sealing position. In the preferred embodiment, the elliptical shape of the handway or manway assembly allows the cover to be inserted externally through the vessel opening and rotated into the internal sealing position. The present invention includes a stay bracket system for assuring that the cover and gasket are properly positioned in the sealing position when the cover is to be mounted in the vessel access opening. The stay bracket system supports the cover and gasket in the sealing position during assembly, thereby eliminating the requirement to forcibly hold the cover and gasket in the sealing position. In doing so the handway/manway installation stay bracket system allows for easier installation of the handway or manway holding hardware.

The handway or manway cover system of the subject invention can be applied to any size handway or manway assembly. The stay bracket system assures that the cover and gasket are properly positioned in the vessel opening for proper sealing. The stay bracket system also provides assistance to the operator reducing the force required to hold the cover in position during assembly, making the process less cumbersome than with prior art systems. Further, the system can be readily retrofitted to vessels in the prior art.

In the preferred embodiment, the cover system comprises an elliptical, bell shaped base having an outer, substantially flat rim. The rim is designed to engage an interior wall of the handway or manway opening in the pressure vessel. A sealing gasket is placed on the rim and is sandwiched between the rim and the pressure vessel. One or more indexing tabs are mounted on the bell shaped housing and provide the stay brackets of the subject invention. These brackets are dimension to engage the inner circumferential wall of the vessel opening for aligning, registering and positioning the cover in the opening. In the preferred embodiment the brackets also help support the cover in place during assembly, minimizing the effort required by the operator to properly secure the cover in the vessel opening. Standard manway crab clamps, well known in the industry, are then used to clamp the cover in place. As the vessel is then pressurized, the cover is forced against the interior wall of the vessels and held in sealing relationship therewith by the positive pressure in the vessel.

### BRIEF DESCRIPTION OF THE DRAWINGS

FIG. 1 is a top view of a typical pressure vessel having a handway or manway access opening in a sidewall thereof and including the cover system of the subject invention.

FIG. 2 is a side view of the pressure vessel of FIG. 1, showing the cover system of the subject invention mounted in the handway or manway access opening.

FIG. 3 is a front view of the cover system bell shaped base, mounting handle and the stay brackets of the subject invention.

FIG. 4 is a side view of the cover system of FIG. 3 and looking in the direction of arrows 4-4.

FIG. 5 is a view looking in the same direction of arrows 5-5 of FIG. 3.

FIG. 6 is a view looking in the same direction as FIG. 3, showing the cover system of the subject invention mounted in the access opening of the vessel, with the crab clamps in locking position.

FIG. 7 is a side view looking in the direction of arrows 7-7 of FIG. 5.

FIG. 8 is a side view looking in the direction of arrows 8-8 of FIG. 5.

### DETAILED DESCRIPTION

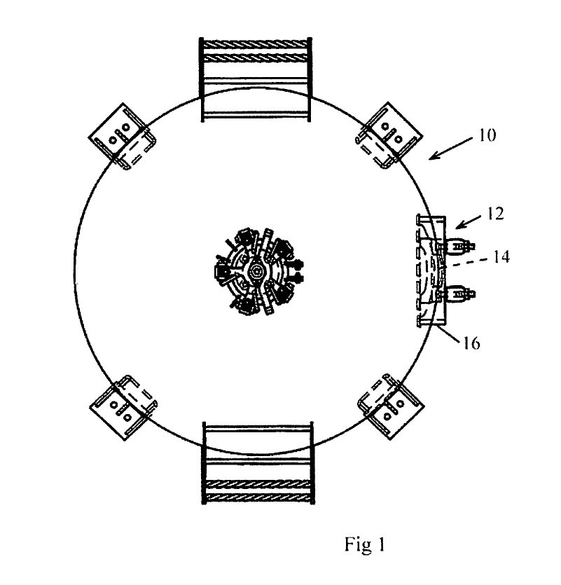

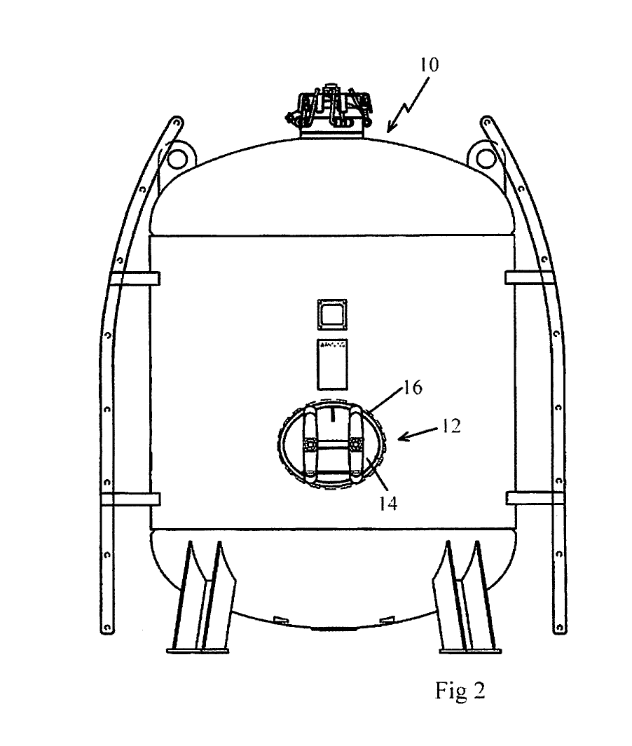

A typical pressure vessel 10 is shown in FIGS. 1 and 2. The vessel includes a handway or manway access opening 12. The cover system 14 of the subject invention is mounted in the opening 12. As shown, the access opening 12 includes an outwardly projecting peripheral wall 16 circumferentially surrounding the opening 12 and containing cover 14 of the subject invention once the cover is in position within the opening.

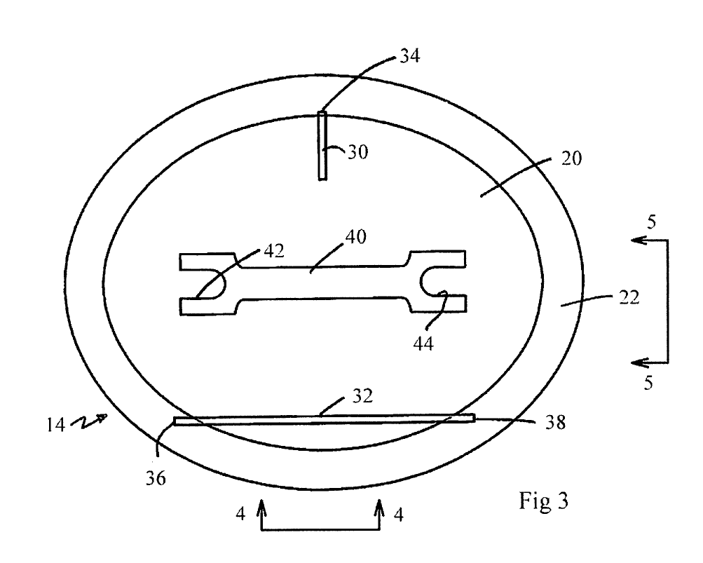

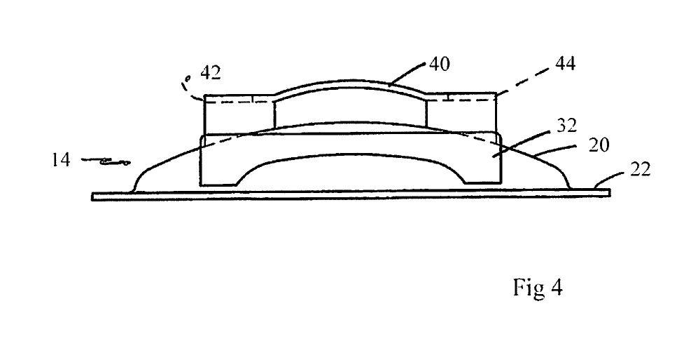

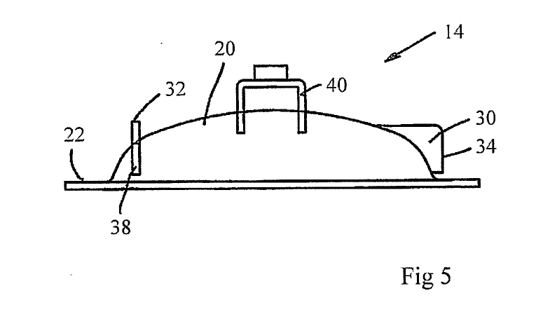

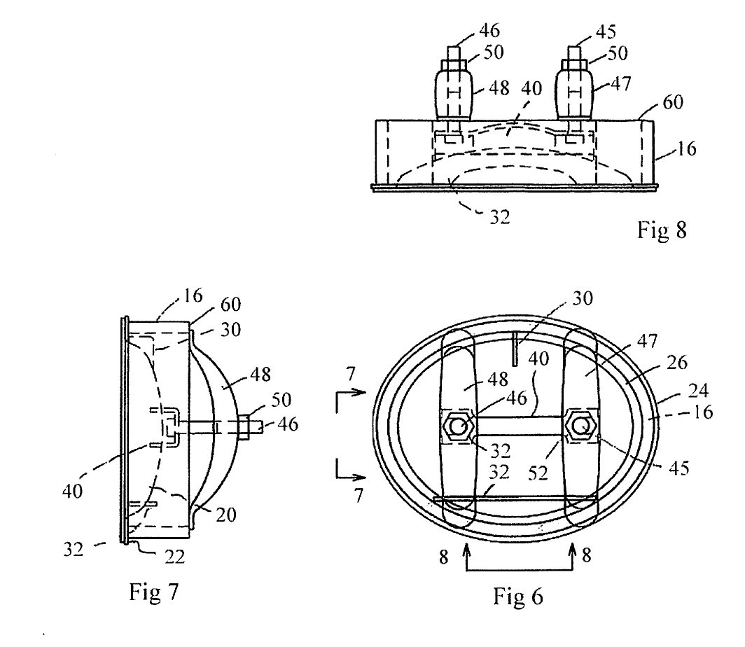

As better shown in FIGS. 3-7, cover assembly 14 includes a bell-shaped elliptical base 20 having an outer, substantially flat rim 22. As can be seen in FIGS. 2 and 6, the outermost edge 24 of the rim 22 extends inwardly of the outer peripheral wall 16 of the vessel opening 12. A gasket 26 is positioned between the rim 22 of the base and the interior sidewall of the vessel 10.

As best shown in FIG. 3, a plurality of stay brackets 30 and 32 are mounted on the base 20. The stay bracket 30 has an outer edge 34 which is adapted to slidably engaging the inside perimeter wall of the opening 12 of the vessel. Likewise, the stay bracket 32 has outer edges 36 and 38 adapted for slidably engaging the inside perimeter wall of the opening 12 of the vessel. These brackets properly position the cover in the opening and support the weight of the cover during lockdown assembly. The number and shape of the brackets is a matter of choice. The key feature is that the brackets are positioned such that they have one or more registration edges for properly positioning the cover 14 in the opening 12. In the preferred embodiment, the two brackets provide a three-point registration system with a minimum number of parts.

As is typical in the industry, a cover handle 40 is mounted on the cover 14. The outer ends of the handle including bolt slots 42 and 44. In assembly, the cover 14 and gasket 26 are properly positioned in the opening 12 of the vessel and held in proper location by the stay brackets 30 and 32. The bolts 45 and 46 are placed through suitable openings 50 in each crab claw 47 and 48 and loosely secured in place by nuts 52. The head 54 of each bolt is then slid into the respective slots 42 and 44 in the handle 40 and the bolt/nut assembly is then tightened to hold the cover in place by tightening the crab claws 47, 48 against the outermost rim 60 of the outwardly extending wall 16 of the opening 12. Once fully assembled in this manner the vessel is ready for pressurization.

The stay brackets are mounted on the bell shaped housing in non-interfering relationship with both the outer rim 22 of the cover and the handle 40, see FIGS. 3, 4 and 5.

The stay brackets of the cover system of the subject invention provides proper positioning and registration of the cover in the opening, supports the cover during assembly and disassembly, and minimizes the holding effort required by the operator during installation assembly and disassembly.

While certain embodiments and features of the invention have been described in detail herein, it should be understood that the invention encompasses all modifications and enhancement within the scope and spirit of the following claims.

What is claimed is:

1. A cover assembly for an access opening in a pressure vessel, wherein the cover is held in sealing position at least partially by the positive pressure in the pressure vessel by engaging an interior wall of the pressure vessel when the pressure vessel is under pressure, the cover assembly comprising:
a. A housing;
b. A peripheral rim on the housing and adapted for engaging the interior wall of the pressure vessel; and
c. Positioning tabs on the housing for engaging and positioning the housing and the peripheral rim relative to the access opening in the pressure vessel.

2. The cover assembly of claim 1, further including gasket positioned on the peripheral rim and located between the peripheral rim and the interior wall of pressure vessel.

3. The cover assembly of claim 1, including a handle mounted on the housing in non-interfering relationship with the positioning tabs.

4. The cover assembly of claim 3, including clamps adapted for selectively engaging the handle and the pressure vessel for securing the cover assembly in position on the pressure vessel and in the access opening.

5. The cover assembly of claim 1, wherein the positioning tabs include three positioning surfaces for engaging and positioning the housing.

6. The cover assembly of claim 5, wherein the three positioning surfaces are located on a total of two tabs.

7. The cover assembly of claim 3, wherein the positioning tabs are in non-interfering relationship with the handle.

8. The cover assembly of claim 3, wherein the positioning tabs are in non-interfering relationship with the peripheral rim.

9. The cover assembly of claim 1, wherein the positioning tabs are in non-interfering relationship both the peripheral rim and the handle.

10. A bracket mounted on the bell shaped elliptical housing of a handway/manway cover for positioning the handway/manway cover in an access opening having a peripheral wall, comprising:
a. A support mounted directly on the bell shaped portion of the bell shaped elliptical housing;
b. An engagement surface on the support adapted for engaging the peripheral wall of the access opening when the handway/manway cover is in position in the access opening.
